(19) United States
(12) Patent Application Publication
(10) Pub. No.: US 2005/0129490 A1
(43) Pub. Date: Jun. 16, 2005

(54) Apparatus and method for lifting and carrying objects on a vehicle

(76) Inventor: Mark L. Hutchins, El Paso, TX (US)

Correspondence Address: James E. Bradley;Bracewell & Patterson, L.L.P., P.O. Box 61389, Houston, TX, 77208-1389, US

(21) Appl. No.: 11/014,331

(22) Filed: Dec. 16, 2004

Related U.S. Application Data
(60) Provisional application No. 60/530,033, filed on Dec. 16, 2003.

(51) Int. Cl. B60P 9/00

(52) U.S. Cl. 414/462

(57) ABSTRACT

The invention includes a lift apparatus for supporting an object in the proximity of a vehicle traversing a terrain. The lift apparatus includes a mounting plate that is mounted to the vehicle, and a platform to support and carry the object. The lift apparatus also includes an arm assembly having a pair of parallel gear arms. The arm assembly is pivotally connected to the mounting plate at an upper end of the arm assembly, and is pivotally connected to the platform at a lower end of the arm assembly. A drive motor assembly is mounted to the mounting plate and is laterally offset from the gear arms. A link extends between the drive motor assembly and one of the gear arms to rotate the gear arms about their upper ends, thereby raising the platform.

### 1. FIELD OF THE INVENTION

The present invention relates generally to a lift apparatus that is attached to a vehicle and, more particularly, to a lift apparatus that may be attached to a female adapter of tow hitch provided at the rear end of a vehicle.

### 2. BACKGROUND OF THE INVENTION

It is often desirable to transport a bulky or odd sized object, such as for example, a wheelchair, a motorcycle, or cargo, which cannot because of its size be fitted into a vehicle. In these situations, the vehicle owner is faced with the options of hiring someone to transport the object, renting a vehicle capable of transporting the object or adding some type of cargo carrier onto their existing vehicle to allow them to transport the object with their vehicle. Some objects are too heavy to lift and, as such, devices that lift and carry objects are needed to raise these objects from ground level to a desired position above ground and hold that position.

It is well known in the field that lifting and carrying devices may be attached to vehicles to aid a user in lifting objects from ground level to a position above ground. Traditional devices are permanently fixed to the vehicle. However, these devices are also very large and cover a substantial area of the rear of the vehicle. Another limitation of the conventional devices is that the carrying device remains in one fixed position when not in use. As such, these devices permanently block the rear doors of vans, tailgates of trucks, trunks of cars and the like. The whole point of purchasing such vehicles, for many people, is to gain the cargo space provided thereby and to gain access to that space through the rear door of the vehicle. If the rear door is rendered useless by the attachment of a vehicle carrier apparatus of the type currently commercially available, the investment in the vehicle is wasted to some extent.

More current devises incorporate under vehicle systems in order to allow access to the rear door of the vehicle while the device remains attached to the vehicle. Many of these devices are located underneath the vehicle below the rear door. It is difficult, however, to position a lift platform under the rear of a vehicle because the rear axle interferes with the stowage of the platform. There is not enough room under most vehicles between the rear axle and the rear door to stow a known lifting platform when not in use.

Other devises incorporate low profile hitch type receivers in order to allow access to the rear door of the vehicle. The devices, unlike its lifting device predecessors, are removable and therefore transferable from vehicle to vehicle by simply sliding them into and out from standard tow hitch receivers found on many trucks, vans and recreational vehicles. These hitch type devices also remedy the problem of axle interference in under vehicle lift systems. However, these prior low profile designs contain significant flaws and limitations that interfere with their utility.

For example, in U.S. Pat. No. 5,122,024, the platform must traverse along a stationary vertical member. This configuration mirrors an elevator system in that the platform must traverse along the vertical member to reach its various positions. As such, the distance that the platform can travel is directly dependent upon and directly limited to the length of the vertical member. This poses a number of problems because the platform may not reach its desired positions. If the vehicle is too high or if the vertical member is not long enough the platform may not reach the ground. Furthermore, if the vertical member, due to being stationary, is located too far above the bumper it will obstruct rear door accessibility in vehicles. A subsequent patent, U.S. Pat. No. 5,431,522 explains another low profile vehicle carrier, however, this patent fails to overcome the limitations of U.S. Pat. No. 5,122,024 because the platform must still traverse along a stationary vertical member, or in this case, an elongated drive screw.

What is desired or needed in the art, therefore, is a lift apparatus that is attachable to the rear end of a passenger vehicle wherein the apparatus does not adversely affect the utility of the vehicle and the apparatus allows flexibility to accommodate vehicles with various heights and configurations.

### 3. SUMMARY

The invention includes a lift apparatus for supporting an object in the proximity of a vehicle traversing a terrain. The lift apparatus includes a mounting plate that is mounted to the vehicle, and a platform to support and carry the object. The lift apparatus also includes an arm assembly having a pair of parallel gear arms. The arm assembly is pivotally connected to the mounting plate at an upper end of the arm assembly, and is pivotally connected to the platform at a lower end of the arm assembly. A drive motor assembly is mounted to the mounting plate and is laterally offset from the gear arms. A link extends between the drive motor assembly and one of the gear arms to rotate the gear arms about their upper ends, thereby raising the platform.

### 4. BRIEF DESCRIPTION OF THE DRAWINGS

FIG. 1 is an isometric view of a lift apparatus in accordance with an embodiment of the invention, illustrating the lift apparatus in a lowered position.

FIG. 2 is an isometric view of the lift apparatus embodiment of FIG. 1, illustrating the lift apparatus in a raised position.

FIG. 3 is a front view of the lift apparatus embodiment of FIG. 1.

FIG. 4 is a bottom view of the lift apparatus embodiment of FIG. 1.

FIG. 5 is a side view of the lift apparatus embodiment of FIG. 1, illustrating the lift apparatus mounted to the rear hitch of a vehicle with a rear door.

FIG. 6 is a side view of the lift apparatus embodiment of FIG. 1, illustrating the lift apparatus mounted to the rear hitch of a vehicle with a tailgate.

FIG. 7 is an isometric view of the lift apparatus embodiment of FIG. 1, illustrating the lift apparatus in the folded position.

FIG. 8 is an isometric view of a lift apparatus in accordance with another embodiment of the invention, illustrating the lift apparatus in a lowered position.

FIG. 9 is an isometric view of the lift apparatus embodiment of FIG. 8, illustrating the lift apparatus in a raised position.

FIG. 10 is an isometric view of a lift apparatus in accordance with another embodiment of the invention.

FIG. 11 is an isometric view of the lift apparatus embodiment of FIG. 10.

FIG. 12 is a side view of an adjustable clamp in the lift apparatus embodiment of FIG. 10.

FIG. 13 is a front view of an adjustable clamp in the lift apparatus embodiment of FIG. 10.

FIG. 14 is an isometric view of a lift apparatus in accordance with another embodiment of the invention.

FIG. 15 is a front view of the lift apparatus embodiment of FIG. 14.

FIG. 16 is a top view of the lift apparatus embodiment of FIG. 14.

FIG. 17 is a side view of the lift apparatus embodiment of FIG. 14.

FIG. 18 is a rear view of the lift apparatus embodiment of FIG. 14.

FIG. 19 is an isometric view of platform of the lift apparatus embodiment of FIG. 14.

FIG. 20 is an isometric view of a set of guide arms and gear arms of the lift apparatus embodiment of FIG. 14.

FIG. 21 is an isometric view of the guide arms and gear arms of FIG. 20, illustrating an electric actuator.

FIG. 22 is an isometric view of the guide arms and gear arms of FIG. 20, illustrating a cable and locking mechanism.

FIG. 23 is an isometric view of a cylinder support assembly of the lift apparatus embodiment of FIG. 14.

FIG. 24 is an isometric view of a lift apparatus in accordance with another embodiment of the invention.

FIG. 25 shows an isometric view of the lift apparatus mounted onto the rear side of a vehicle.

### 5. DETAILED DESCRIPTION OF THE INVENTION

Although the following detailed description contains many specific details for purposes of illustration, anyone of ordinary skill in the art will appreciate that many variations and alterations to the following details are within the scope of the invention. Accordingly, the exemplary embodiment of the invention described below is set forth without any loss of generality to, and without imposing limitations thereon, the claimed invention.

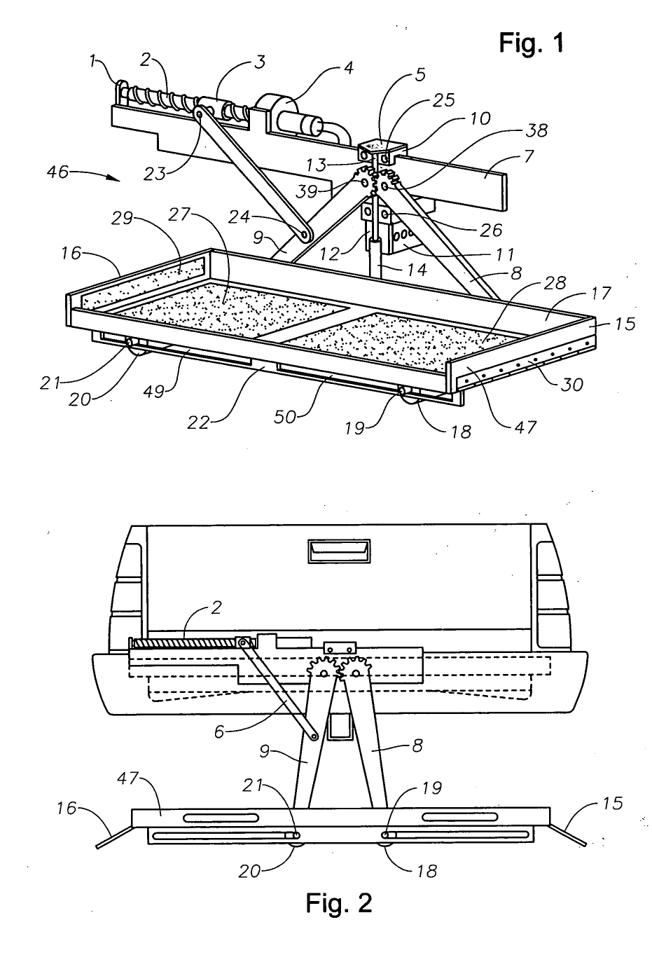

FIG. 1 illustrates an embodiment of a lift apparatus 46 of the present invention. The lift apparatus 46 may include a back plate 7 affixed with a power screw fixture 1, which may secure a gear-driving device such as a power screw 2, commonly known as a worm gear. A motor 4 may be used to turn the power screw 2, thereby causing a power screw collar 3 to traverse along a power screw 2. The power screw 2 may also be turned manually or hydraulically. As a power screw collar 3 traverses along a power screw 2, a torque transfer arm 6 may raise or lower a left gear arm 9 which in turn may cause a right gear arm 8 to raise or lower simultaneously with the left gear arm 9. One end of the gear arms 8, 9 may comprise a meshing mechanism, such as sprockets or teeth, that when turned allow for simultaneous raising or lowering of the platform 47. The torque transfer arm 6 may be affixed to a power screw collar 3 and a left gear arm 9 with respective bolts 23, 24. The gear arms 8, 9 may be affixed to a back plate 7 with bolts 38, 39 and rotate radially about said bolts 38, 39.

The hitch adapter 11 may comprise a plurality of holes to enable the lift apparatus 46 to be adjusted closer or farther from the vehicle in order to accommodate differences in vehicle configurations. The hitch adapter 11 may be affixed by conventional means, such as welding, to a bracket plate 12, which in turn may be affixed to a back plate 7 with bolts 26. The horizontal plane guide 5 may be affixed on top of a lift bracket 10, which may be affixed to a back plate 7 with bolts 25. A female guide base component 14 may connect to a horizontal plane guide base 5 and a platform 47.

Still referring to FIG. 1, the platform 47 may comprise a collapsible back plate 17, a right access exit collapsible ramp 15 and right access exit collapsible ramp 16. The collapsible ramps 15, 16 may be spring loaded with a spring-loaded joint 30 such that the collapsible ramps 15, 16 may fold outward and spring back upright. The collapsible ramps 15, 16 may further include a no slip surface 29. The collapsible back plate 17 may be spring loaded with a spring loaded joint 30 such that the collapsible back plate 17 may fold inward to allow for the platform 47 to be placed in the stored position, then spring back upright when unfolded. The bottom plates 27, 28 of the platform 47 may also include a no slip surface. A roller lift arm guide plate 22 with slots 49, 50 may lie below and affixed to the platform 47. Roller arms 18, 20 may house roller arm pins 19, 21. As gear arms 8, 9 raise and lower, the roller arms 18, 20 may traverse across the bottom of the platform 47 as the roller arm pins 19, 21 traverse within the slots 49, 50.

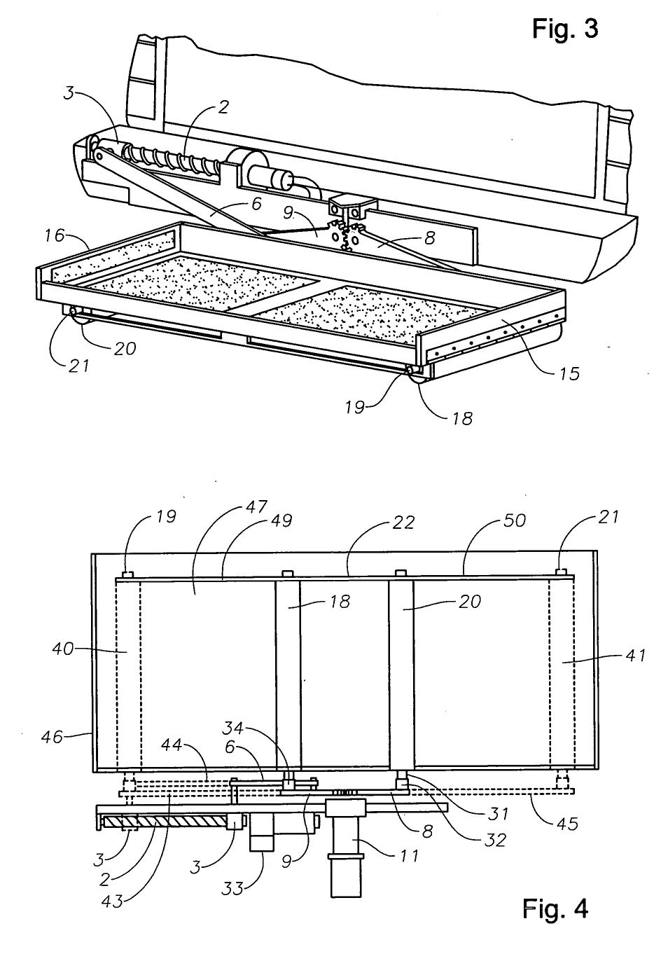

FIG. 2 illustrates the platform 47 in a lowered position, and shows the right and left collapsible ramps 15, 16 in the fold-down position to allow users to easily place items such as wheel chairs, scooters, ATV vehicles, snowmobiles, motorcycles, other motorized vehicles, or cargo onto the platform 47. FIG. 3 illustrates the platform 47 in a raised position.

Referring to FIG. 4, when lowering the platform 47, the DC motor 4 turns the power screw 2 thereby causing the power screw collar 3 to traverse toward one end of the power screw 2. The torque transfer arm 6 extends to one of the gear arms, thereby causing the gear arms 8, 9 to move in a downward direction. As the gear arms 8, 9 move downward, the roller arms 18, 20 traverse along the platform 47 in an inward direction and may reach full low position when the pins 19, 21 reach the end of the slots 49, 50. Collapsible lift arm rods 31, 33 connect the roller arms 18, 20 to the arm fixtures 32, 34, which are affixed to the gear arms 8, 9.

Still referring to FIG. 4, when raising the platform 47, as shown in the dashed lined diagram of FIG. 4, the DC motor 4 turns the power screw 2 thereby causing the power screw collar 3 to traverse toward an opposite end of the power screw 2. The torque transfer arm 44 extends to one of the gear arms, thereby causing the gear arms 43, 45 to move in an upward direction. As the gear arms 43, 45 move upward, the roller arms 40, 41 traverse along the platform 47 in an outward direction and may reach full height position when the pins 19, 21 reach the other end of the slots 49, 50.

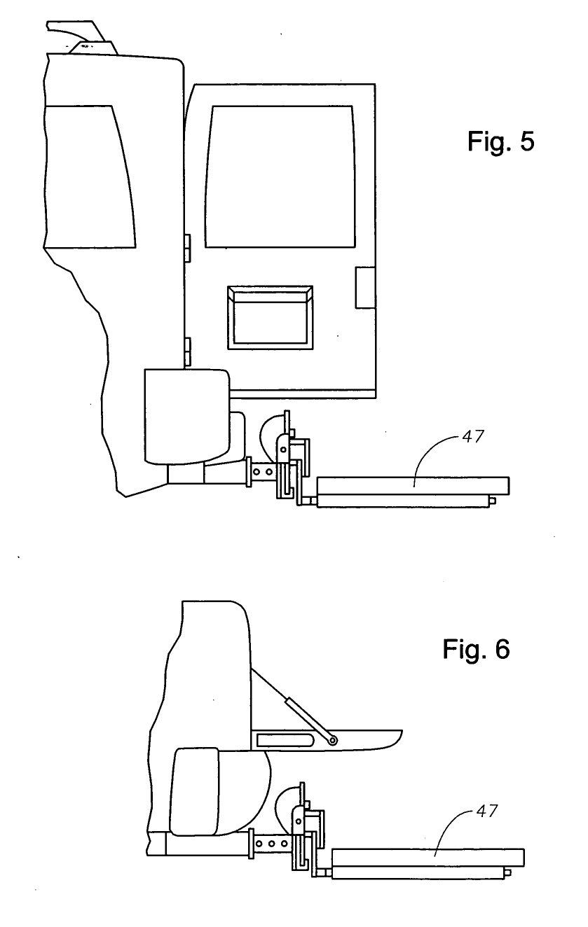

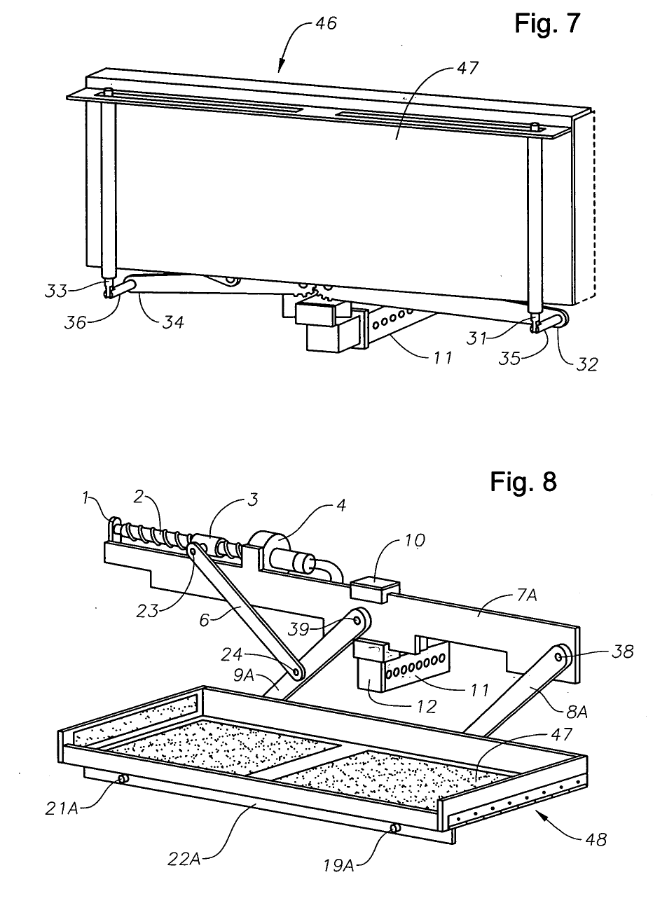

FIG. 5 illustrates the lift apparatus mounted to the rear hitch of a vehicle with a rear door, shown with the door ajar to show rear door clearance. FIG. 6 illustrates the lift apparatus mounted to the rear hitch of a vehicle with a tailgate, shown with the tailgate down to show tailgate clearance. FIG. 7 illustrates the lift apparatus in a folded or stowed position. The arm pins 35, 36 may create a joint between the collapsible lift arm rods 31, 33 and the arm fixtures 32, 34 to allow the platform 47 to fold substantially perpendicular to the hitch adapter 11.

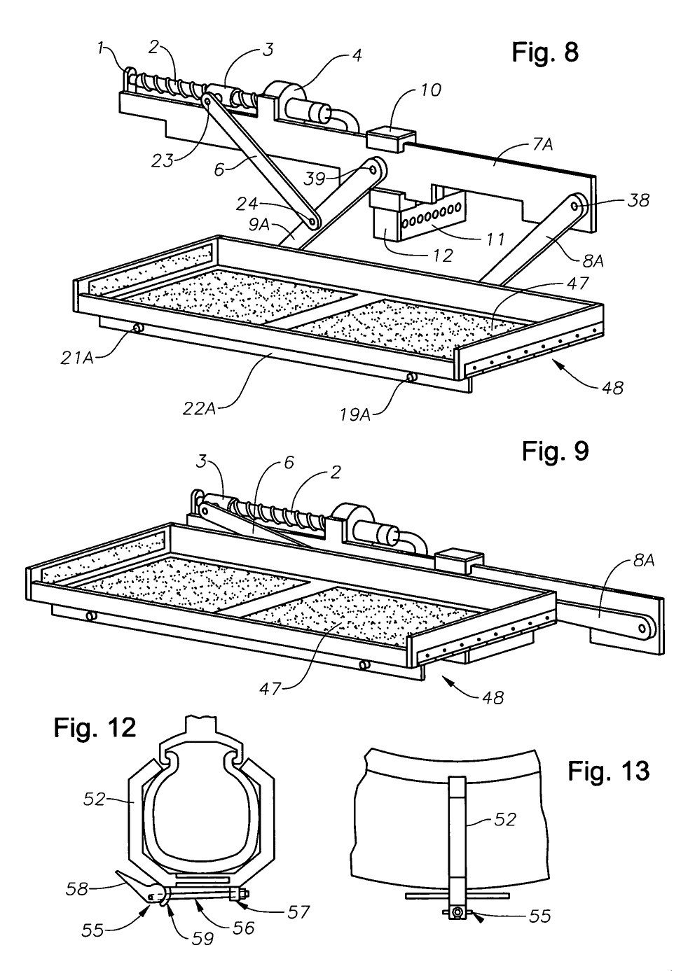

FIG. 8 illustrates another embodiment of the invention shown in a lowered position, and FIG. 9 illustrates the embodiment in a raised position. Lift apparatus 48 may include a back plate 7A affixed with a power screw fixture 1, which may secure a gear driving device such as a power screw 2, commonly known as a worm gear. A motor 4 may be used to turn the power screw 2, thereby causing a power screw collar 3 to traverse along a power screw 2. The power screw 2 may also be turned manually or hydraulically. As a power screw collar 3 traverses toward one end of a power screw 2, a torque transfer arm 6 affixed to a left arm swing 9A, may cause arm a left swing 9A to raise platform 47. As a power screw collar 3 traverses toward an opposite end of a power screw 2, a torque transfer arm 6, affixed to a left arm swing 9A, may cause arm a left swing 9A to lower platform 47. The arms swings 8A, 9A may be solidly affixed to the platform lift arm plate 22A with platform pins 19A, 21A. The right arm swing 8A may raise or lower freely with respect to and simultaneously to the left arm swing 9A. The torque transfer arm 6 may be affixed to a power screw collar 3 and a left arm swing 9A with respective bolts 23, 24. The arms swings 8A, 9A may be affixed to a back plate 7A with bolts 38, 39. The hitch adapter 11 may comprise a plurality of holes to enable the lift apparatus 46 to be adjusted closer or farther from the vehicle in order to accommodate differences in vehicle configurations. The hitch adapter 11 may be affixed by conventional means, such as welding, to a bracket plate 12 and a lift bracket 10, which in turn may be affixed to a back plate 7A.

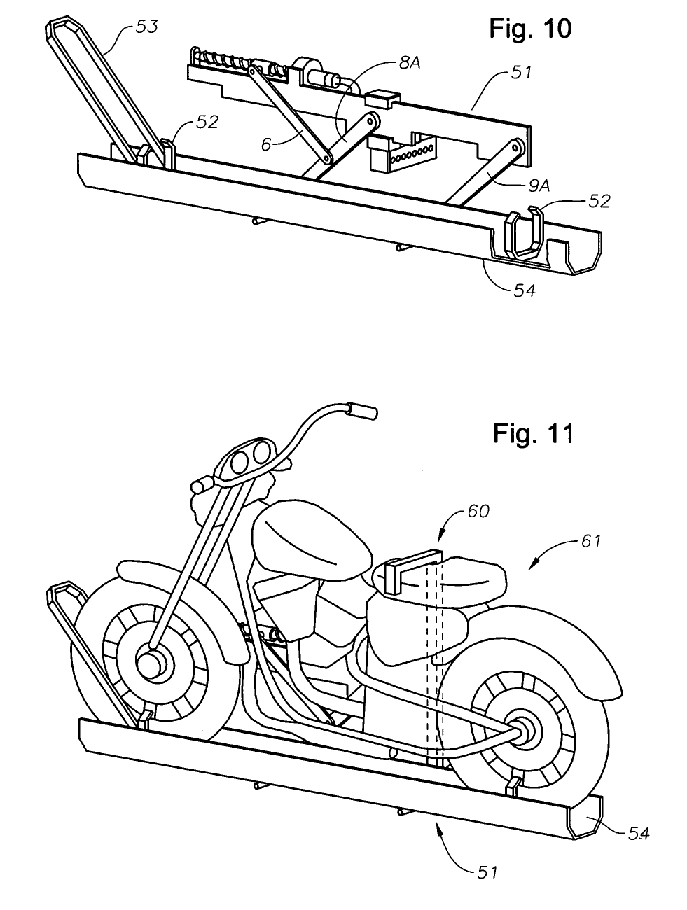

FIG. 10 illustrates another embodiment of a lift apparatus 51. The lift apparatus 51 may have a tubular platform 54 to accommodate items such as a bicycle or motorcycle. Adjustable clamps 52 may be affixed to platform 54 to secure the wheels of a bicycle or a motorcycle to platform 54. A retaining rack 53 may be affixed to platform 54 to secure bicycle or motorcycle about an upright position. FIG. 11 illustrates the lift apparatus 51 with an adjustable securing device 60 to further secure a traveling apparatus, such as a bicycle 61, onto the platform 54. FIG. 12 illustrates a side view of the adjustable clamp 52 with a locking device 55, and FIG. 13 illustrates a front view of the clamp 52. The locking device 55 may comprise a threaded rod 56, a nut 57 and a lever 58. The user locks the wheel into the platform 54, and may seat the lever 58 into the hook 59 and close the lever 55 to secure the wheel into the locking device 55. To unlock the locking device 55, the user may open the lever 58 and remove the lever 55 from hook 59. The adjustable clamp tension may be adjusted by turning the nut 57.

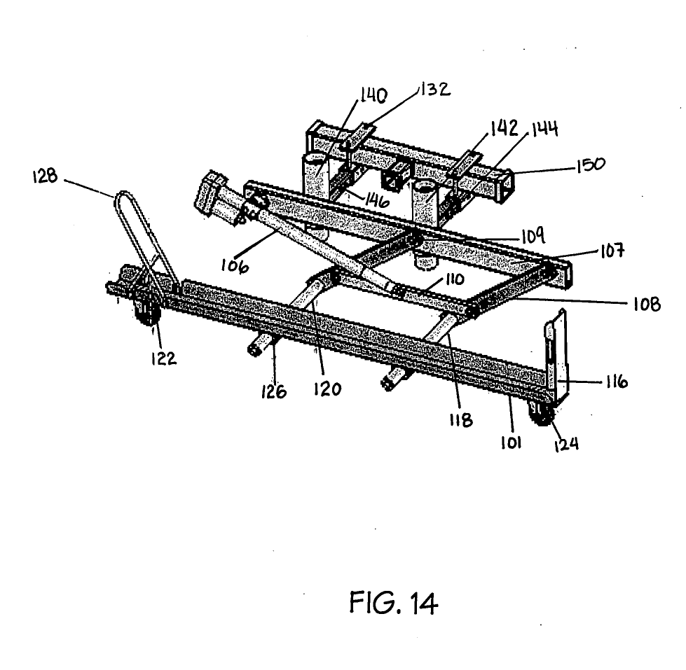

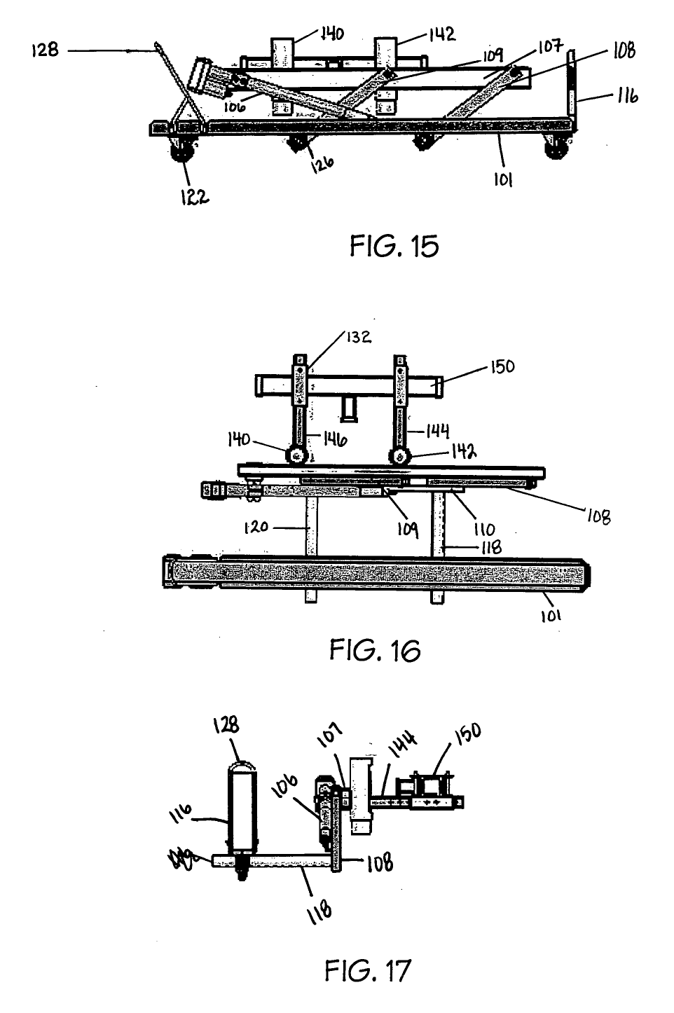

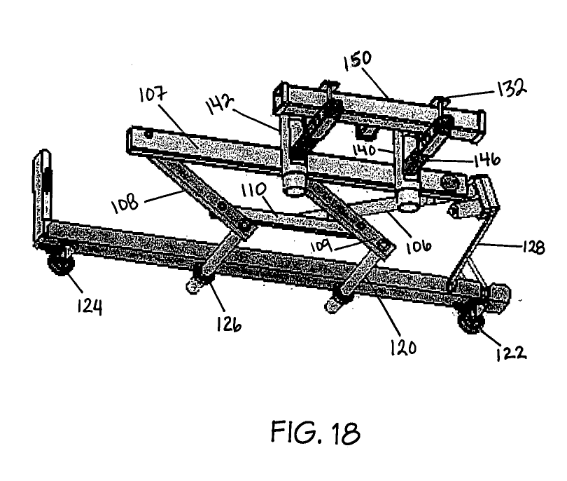

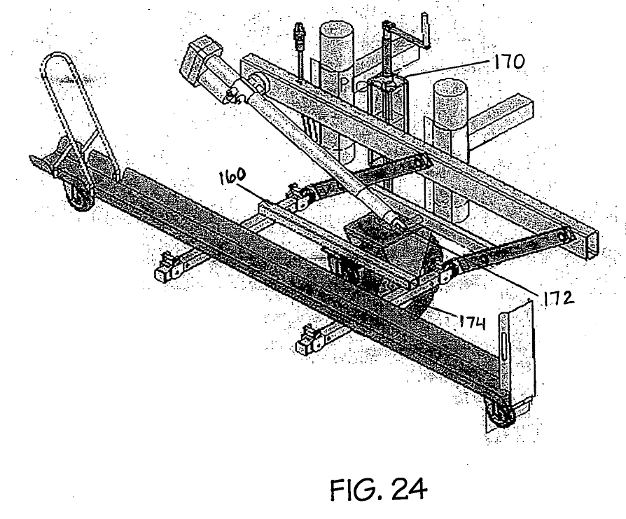

FIGS. 14-18 show several different views of another embodiment of the lift apparatus, including a tubular platform 101. A pair of collars 126 are rigidly mounted on the underside of the platform 101. A right guide arm 118 and a left guide arm 120 extend through the collars 126, and collars 126 mounted to the platform 101 are capable of traversing along the guide arms 118, 120. A rim 160, as shown in FIG. 24, may be included on the guide arms 118, 120, for providing a boundary to prevent further displacement of the platform 101 along the guide arms 118, 120. The ability of the platform 101 to move along the guide arms 118, 120 allows for proper position of the platform 101 along the guide arms, and also allows for multiple platforms 101 to potentially fit on the length of the guide arms 118, 120, provided that the guide arms 118, 120 are lengthy enough to support more than one platform 101.

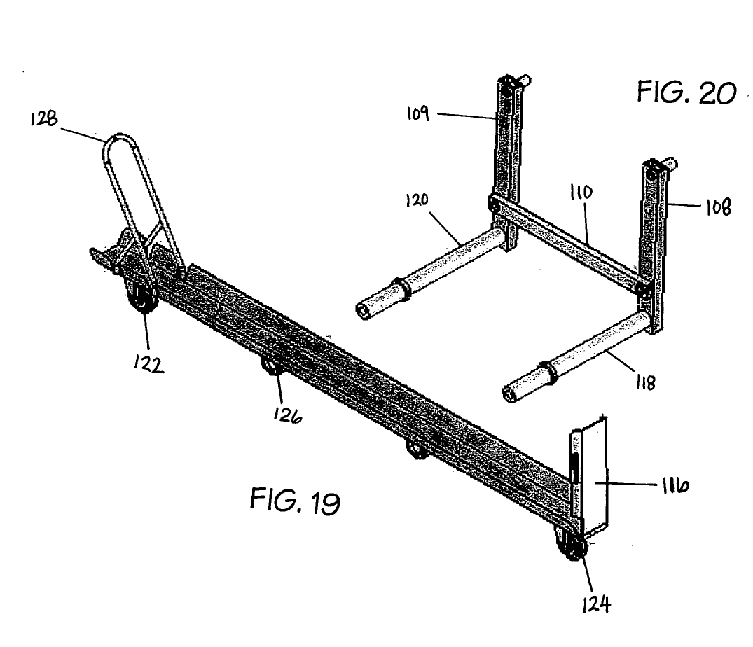

The tubular platform 101 may have a retaining rack 128 mounted on one lateral side of the platform 101, and a collapsible ramp 116 mounted on the other lateral side of the platform 101, as shown in FIG. 19. The ramp 116 has a dual purpose. First, the ramp 116 provides a means to smoothly guide the load onto the platform 101. Second, after the load is positioned properly on the platform 101, the ramp 116 folds up to support the load at its rear end, while the retaining rack 128 supports the load at its front end, thereby ensuring the load is supported on both of its lateral sides. Additionally, a pair of small wheels 122, 124 is positioned on the underside of the platform 101 at each lateral end of the platform 101 for additional support when the platform 101 is lowered toward the ground.

Referring to FIGS. 14-18, the right guide arm 118 is joined by a pin to an end portion of gear arm 108, and the left guide arm 120 is joined by a pin to an end portion of gear arm 109, as shown also in FIG. 20. The end portions of gear arms 108, 109 opposite from the guide arms 118, 120 are joined by pins to the back plate 107. A torque transfer arm 106 is mounted to the back plate 107, and operates to raise and lower the platform 101. The torque transfer arm 106 may be a hydraulic, electrical, mechanical, or manual mechanism, or another suitable mechanism. The torque transfer arm 106 is attached to an intermediate gear arm 110 that is joined to the middle portion of the left gear arm 109 by a pin, and extends to the middle portion of the right gear arm 108 where it is joined by a pin.

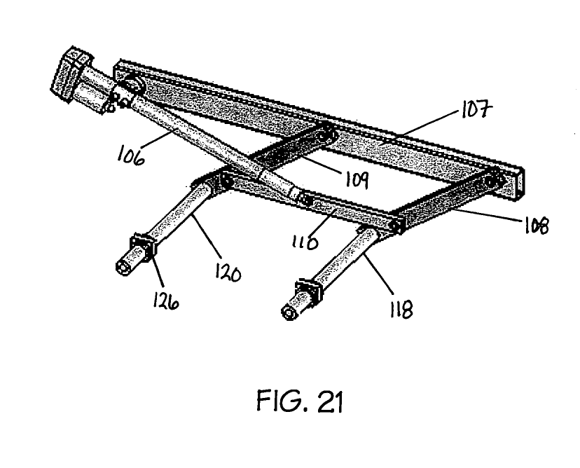

FIG. 21 shows an embodiment of the invention utilizing an electrical acutator as the torque transfer arm 106, utilizing electric actuator to effectuate the raising and lowering of the platform 101. The actuator may provide as much as 6000 lbs. of torsion to raise and lower the platform 101. As the torque transfer arm 106 applies a force to the intermediate gear arm 110, the intermediate gear arm 110 causes the right gear arm 108 and the left gear arm 109 to swing in an angular motion. When the torque transfer arm 106 applies a pulling force on the intermediate gear arm 110, the gear arms 108, 109 swing upward, causing the platform 101 to be raised. When the torque transfer arm 106 applies a pushing force on the intermediate gear arm 110, the gear arms 108, 109 swing downward, causing the platform 101 to be lowered.

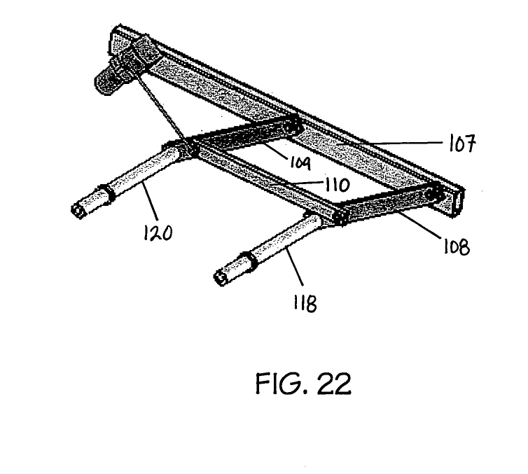

FIG. 22 shows another embodiment of the invention utilizing a wire or cable as the torque transfer arm 106, utilizing a pulling force from the wire or cable to raise the platform 101 and a gravitational force to lower the platform 101 (while relaxing the pulling force of the wire or cable). As the torque transfer arm 106 applies a force to the intermediate gear arm 110, the intermediate gear arm 110 causes the right gear arm 108 and the left gear arm 109 to swing in an angular motion. When the torque transfer arm 106 applies a pulling force on the intermediate gear arm 110, the gear arms 108, 109 swing upward, causing the platform 101 to be raised. When the platform 101 is raised to the desired vertical level, a locking mechanism may lock the wire or cable in place in order to stabilize the platform 01 in place. When the torque transfer arm 106 releases the pulling force of the wire or cable on the intermediate gear arm 110, a gravitational force causes the gear arms 108, 109 swing downward, allowing the platform 101 to be lowered.

Referring to FIGS. 14-18, a pair of cylindrical supports 140, 142 is mounted to the back plate 107, on the opposite side of the back plate 107 from where the gear arms 108, 109 and the torque transfer arm 106 are mounted. A pair of extension arms 144, 146 extend from the cylinder supports 140, 142 and are mounted to a bracket arm 150. The bracket arm 150 is positioned perpendicular to the extension arms 144, 146. A brace plate 132 mounted to each of the extension arms 144, 146 braces the bracket arm 150 to each of the extension arms 144, 146.

Referring to FIG. 24, an adjustment mechanism 170 is used for adjusting the position or the relative height of the lift apparatus. The adjustment mechanism 170 is mounted to the back plate 107, on the same side of the back plate 107 on which the cylinder supports 140, 142 are mounted. The adjustment mechanism 170 extends vertically downward and mounts to an upward facing surface of a wheel housing 172, inside of which a large support wheel 174 resides. The adjustment mechanism 170 is adjusted to the proper height upon which the large support wheel 174 contacts the relative height of the ground surface, so that the platform 101 maintains an adequate ground clearance in both standard road conditions and off-road conditions. The adjustment mechanism may be a lead screw hand crank, or other suitable mechanism for adjusting the wheel.

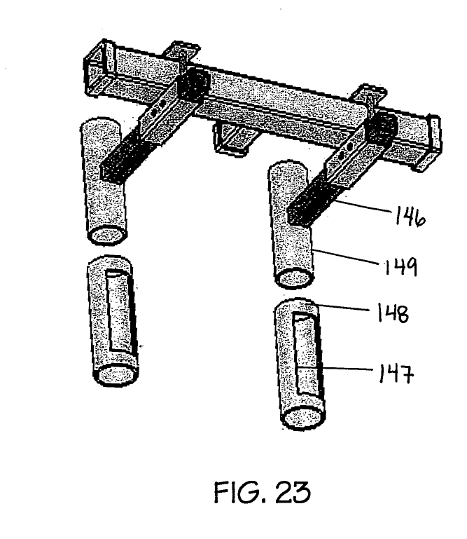

The cylinder supports 140, 142 are designed to cause the support wheel 174 to support the weight of the load on the platform 101, so that the rear of the vehicle does not have the burden or strain of supporting the load. As shown in FIG. 23, the cylinder supports 140, 142 include a female cylinder 148 with a larger diameter and a male cylinder 149 with a smaller diameter. The male cylinder 149 is mounted to an extension arm 146 extending perpendicular from the middle of the male cylinder 149. The female cylinder 148 is mounted onto the back plate 107, and the male cylinder 149 fits inside and traverses vertically within the female cylinder 148. The female cylinder 148 features a cut-away section 147 through which the extension arm 146 extends. The extension arm 146 traverses vertically along the cut-away section 147 as the female cylinder 148 traverses vertically within the male cylinder 149.

A lubricant may be used between the female cylinder 148 and the male cylinder 149 to reduce the friction created between the female cylinder 148 and the male cylinder 149. Alternatively, bushings, ball bearings, precision balls, or other friction reducing elements may be used betwen the female cylinder 148 and the male cylinder 149. Additionally, an impact absorber may be coupled with the cylinder supports 140, 142 to absorb the impact of the vertical movements of the vehicle and the lift apparatus upon the terrain. For example, the impact absorber may include shock absorbers, struts, springs, or another force-absorbing element may be used in association with the cylinder supports 140, 142 in order to reduce the impact of uneven terrain on the lift apparatus.

The cylinder supports 140, 142 enable the support wheel 174 to operate independently of the vehicle. The support wheel 174 supports the entire load, which enables the rear of the vehicle to be free from the load on the platform 101. The support wheel 174 operates with full flexibility to move independently of the vehicle, which may be important when operating the vehicle on inclined roadways or uneven terrain.

The support wheel 174 is responsible for supporting only the weight of the carried load on the platform 101, and thus the support wheel 174 is never responsible for supporting the additional load of the entire vehicle. Furthermore, the vehicle suspension system is unaffected by the load, and the rear portion of the vehicle is not responsible for supporting the load vertically. The cylinder supports 140, 142 and support wheel 174 cause the vehicle receiver hitch to be unaffected by the load on the platform 101, but the vehicle continues to provide lateral support for the lift apparatus while in transit.

The independent movement of the lift apparatus relative to the vehicle is important in cases where the load on the platform 101 is of a substantial weight. A standard hitch (Class C) has a tongue load carrying capacity of approximately 500 lbs. The cylinder supports 140, 142 and the support wheel 174 enable the lift apparatus to carry in excess of 900 lbs., because the vehicle receiver hitch is not burdened by the 900 lb. load.

Another embodiment of the lift apparatus may include an actuator (not shown), or alternatively a winch mechanism (not shown) that allows the user to detach the lift cable from the lift apparatus and use it for a standard 2000 lb. winch. The winch allows dual use of the electrical power system to operate the lift apparatus to lift the platform 101, and additionally may be used to attach the vehicle to a strong point and pull the vehicle from mud, snow, or other difficult terrain.

In operation, and in accordance with an embodiment of a motorcycle load supported on the platform 101 of FIG. 14, the user first pushes a switch button on the lift apparatus to cause the torque transfer arm 106 to lower the platform 101. After the platform 101 reaches the ground, the user swings the ramp 116 about its hinge and rests the end portion of the ramp 116 on the ground. The user rolls the tires of the motorcycle up the ramp 116 and onto the platform 101, into engagement with the retaining rack 128. Then the user straps a series of cables or tie-downs to various points on the motorcycle to secure the motorcycle in place. For example, the user may strap the tie-downs around the handlebars and the neck of the motorcycle until the tightening of the straps causes the suspension to begin to drop. The user may also use a cross-tie to provide balance. After the straps or tie-downs are sufficiently tight around the motorcycle, the user swings the ramp 116 about its hinge until it contacts the rear tire of the motorcycle. A strap is wrapped around the rear tire and tied to the ramp 116 for lateral support. The retaining rack 128 provides lateral support for the front tire of the motorcycle. Finally, the user presses the switch button on the lift apparatus to cause the torque transfer arm 106 to raise the platform 101, and operates the vehicle to transport the motorcycle to the desired destination.

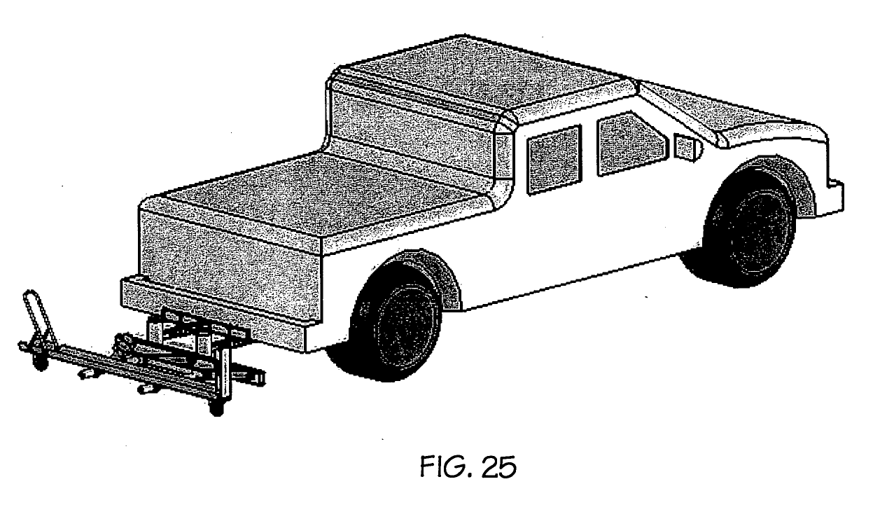

FIG. 25 shows the lift apparatus used in connection with a truck. The lift apparatus may also be used in connection with sport utility vehicles, vans, automobiles, and other recreational vehicles that have a tow hitch, trailer hitch, bumper hitch, or other mounting structure at the rear of the vehicle. The lift apparatus may be operated electrically, hydraulically, mechanically, or manually to raise the platform 101 from a first level to a second level in order to provide substantial ground clearance to the rear of a vehicle. The lift apparatus attaches to the rear of the vehicle and lowers to ground level for positioning an object on the platform 101. This ground level position is highly desirable because disabled people may drive their powered vehicles onto the platform in preparation for storage and transportation. Furthermore, this ground level position allows users to easily slide or roll objects onto the lift apparatus thereby reducing physical stress or strain to their bodies. The platform may be varied about any position between the first substantially horizontal position and a second substantially vertical position. The platform may also be raised or lowered in these varied positions by using the adjustment mechanism 170.

The invention also provides other important advantages. In some embodiments, when in the stowed position, the platform may fold securely to a position substantially parallel to the rear door of the vehicle and substantially perpendicular to the ground, thereby creating a compact assembly that minimally extends the overall length of the vehicle. While in this folded position, the platform may be raised or lowered.

Another advantage is that the lift is relatively simple to install and to remove. It provides a safe and secure means of transporting a variety of cargo and accessories. It is universally adaptable to any type of vehicle, regardless of make, model or size. It does not require attachment to the bumper or bumper mounting brackets, frame of the vehicle, or the body of the vehicle.

Another advantage is that the lift apparatus of the invention may be adjusted closer or farther from the rear of the vehicle in order to accommodate differences in vehicle configurations. For example, custom bumpers may extender father from the vehicle than would a vehicle manufacturer's standard bumper. Some vehicles have optional spare tire mounts that attach to the rear of the vehicle. In both of these examples, the lift apparatus can be adjusted to accommodate these variations. It is adaptable to any size receiver hitch configuration. Also the lift apparatus may not be subject to state motor vehicle licensing fees, as in the case with wheeled devices.

Although some embodiments of the present invention have been described in detail, it should be understood that various changes, substitutions, and alterations can be made hereupon without departing from the principle and scope of the invention. Accordingly, the scope of the present invention should be determined by the following claims and their appropriate legal equivalents.

1. A lift apparatus for supporting an object in the proximity of a vehicle traversing a terrain, the lift apparatus comprising:
a mounting plate adapted to be mounted to the vehicle;
a platform adapted to support and carry the object;
an arm assembly pivotally connected to the mounting plate at an upper end of the arm assembly and pivotally connected to the platform at a lower end of the arm assembly, the arm assembly comprising a pair of parallel gear arms;
a drive motor assembly mounted to the mounting plate and laterally offset from the gear arms; and
a link extending between the drive motor assembly and one of the gear arms to rotate the gear arms about their upper ends, thereby raising the platform.

2. The lift apparatus of claim 1, wherein:
the lift apparatus further comprising a pair of collars rigidly affixed to the platform; and
the arm assembly further comprises a pair of guide arms extending through the collars to support the platform, the guide arms being pivotally connected to the gear arms and extending outward substantially perpendicular from the mounting plate to allow the platform to slide toward and away from the mounting plate, the gear arms being pivotally connected to the mounting plate.

3. The lift apparatus of claim 1, wherein the arm assembly further comprises an intermediate gear arm pivotally connected at one end to a portion of the left gear arm and at another end to a portion of the right gear arm.

4. The lift apparatus of claim 1, wherein the drive motor assembly comprises a rotatably driven worm gear, and wherein the link comprises a rigid bar having a lower end pivotally connected to one of the gear arms and an upper end pivotally connected to the worm gear.

5. The lift apparatus of claim 1, wherein drive motor assembly comprises an actuator, and wherein the link comprises a telescoping member having a lower end pivotally connected to one of the gear arms.

6. The lift apparatus of claim 1, wherein the drive motor assembly comprises a rotatably driven winch, and wherein the link comprises a cable attached to one of the gear arms.

7. The lift apparatus of claim 1, further comprising a ramp hingeably mounted to a first side of the platform by a hinge at an end of the ramp, the ramp being moveable in an angular direction about the hinge, whereby the ramp contacts the ground before loading the object onto the platform and whereby the ramp supports the object on the platform after loading the object onto the platform.

8. The lift apparatus of claim 1, further comprising a retainer mounted to a second side of the platform whereby the retainer supports the object on the platform after loading the object onto the platform.

9. The lift apparatus of claim 1, further comprising a wheel assembly mounted to and extending downward from the mounting plate to contact the terrain and to support the platform.

10. The lift apparatus of claim 1, further comprising:
a first guide member slideable within a second guide member in a substantially vertical direction, the second guide member being mounted to the mounting plate and the first guide member adapted to be mounted to the vehicle; and
a wheel assembly mounted to and extending downward from the mounting plate to contact the terrain and to support the platform, the vertical displacement of the second guide member being independent of the vertical displacement of the first guide member, thereby causing the vertical displacement of the wheel and the platform to be independent of vertical displacement of the vehicle.

11. A lift apparatus for supporting an object in the proximity of a vehicle traversing a terrain, the lift apparatus comprising:
a mounting plate adapted to be mounted to the vehicle;
a platform adapted to support and carry the object;
a lifting assembly pivotally connected to the platform at a lower end and pivotally connected to the mounting plate at an upper end;
a first guide member slideable within a second guide member in a substantially vertical direction, the second guide member being mounted to the mounting plate and the first guide member adapted to be mounted to the vehicle; and
a wheel assembly mounted to and extending downward from the mounting plate to contact the terrain and to support the platform, the vertical displacement of the second guide member being independent of the vertical displacement of the first guide member, thereby causing the vertical displacement of the wheel and the platform to be independent of vertical displacement of the vehicle.

12. The lift apparatus of claim 11, wherein the guide members further comprise an impact absorber coupled with the guide members and adapted to absorb the impact of vertical movements upon traversing the terrain.

13. The lift apparatus of claim 11, wherein the lifting assembly further comprises:
a pair of collars rigidly affixed to the platform; and
a pair of guide arms extending through the collars to support the platform, the guide arms being pivotally connected to the gear arms and extending outward substantially perpendicular from the mounting plate to allow the platform to slide toward and away from the mounting plate, the gear arms being pivotally connected to the mounting plate.

14. The lift apparatus of claim 11, wherein the lifting assembly further comprises:
an arm assembly pivotally connected to the mounting plate at an upper end of the arm assembly and pivotally connected to the platform at a lower end of the arm assembly, the arm assembly comprising a pair of parallel gear arms;
a drive motor assembly mounted to the mounting plate and laterally offset from the gear arms; and
a link extending between the drive motor assembly and one of the gear arms to rotate the gear arms about their upper ends, thereby raising the platform.

15. The lift apparatus of claim 14, wherein the lifting assembly further comprises an intermediate gear arm pivotally connected at one end to a portion of the left gear arm and at another end to a portion of the right gear arm.

16. The lift apparatus of claim 11, further comprising a ramp hingeably mounted to a first side of the platform by a hinge at an end of the ramp, the ramp being moveable in an angular direction about the hinge, whereby the ramp contacts the ground before loading the object onto the platform and whereby the ramp supports the object on the platform after loading the object onto the platform.

17. The lift apparatus of claim 11, further comprising a retainer mounted to a second side of the platform whereby the retainer supports the object on the platform after loading the object onto the platform.

18. The lift apparatus of claim 11, further comprising an adjustment mechanism rigidly mounted to the mounting plate and coupled to the wheel for adjusting the vertical position of the wheel relative to the mounting plate.

19. A lift apparatus for supporting an object in the proximity of a vehicle traversing a terrain, the lift apparatus comprising:
a mounting plate adapted to be mounted to the vehicle;
a platform adapted to support and carry the object;
a pair of guide plates rigidly mounted to the platform and spaced horizontally apart from each other, each guide plate defining a lateral elongated slot;
a pair of substantially horizontal support members to support the platform and slideably engage each of the slots of the guide plate, the horizontal support members extending perpendicular to the mounting plate;
a left gear arm and a right gear arm each being pivotally connected at one end to each of the horizontal support members and at another end to the mounting plate, the gear arms each having a plurality of teeth at the end pivotally connected to the mounting plate;
a drive motor assembly mounted to the mounting plate and laterally offset from the gear arms;
a link extending between the drive motor assembly and one of the gear arms to rotate the gear arms about their upper ends, thereby raising the platform; and
a substantially vertical telescoping support member adapted to stabilize the platform after the object is positioned on the platform, the telescoping support member having an upper end connected to the mounting plate and a lower end connected to the platform.

20. The lift apparatus of claim 19, wherein:
the drive motor assembly comprises a worm gear mounted on the mounting plate; and
the link comprises a torque arm pivotally connected at one end to the worm gear and at another end to one of the gear arms, the torque arm driving movement of the gear arms by causing the teeth of one of the gear arms to mesh with the teeth of the other of the gear arms, to thereby cause the horizontal support members to outwardly traverse the lateral slots on the guide plate when raising the platform and to thereby cause the horizontal support members to inwardly traverse the lateral slots on the guide plate when lowering the platform.
